(19) United States
(12) Patent Application Publication
(10) Pub. No.: US 2004/0015872 A1
(43) Pub. Date: Jan. 22, 2004

(54) Process and system for validating a computer program segment

(75) Inventor: David Crocker, Ash Vale (GB)

Correspondence Address: William R. Evans, Ladas & Parry, 26 West 61 Street, New York, NY, 10023, US

(73) Assignee: ESCHER TECHNOLOGIES LTD

(21) Appl. No.: 10/091,124

(22) Filed: Mar. 5, 2002

(30) Foreign Application Priority Data
Mar. 8, 2001 (GB) 0105733.0

(51) Int. Cl. G06F 9/44

(52) U.S. Cl. 717/126; 717/116

(57) ABSTRACT

A method for ensuring that a program using dynamic binding and recursion is free from unbounded recursion is provided, together with a method for automatically constructing a set of mathematical theorems that are all true theorems if the program is indeed free from unbounded recursion. In a preferred embodiment, a computer program generates the set of theorems automatically from information in the program and the same or another computer program attempts to prove the theorems, with or without human assistance.

This invention relates to the validation of a computer program segment.

Most computer programs contain bugs (i.e. software errors). Some bugs are caused by programming errors. One of the types of programming error is unbounded recursion.

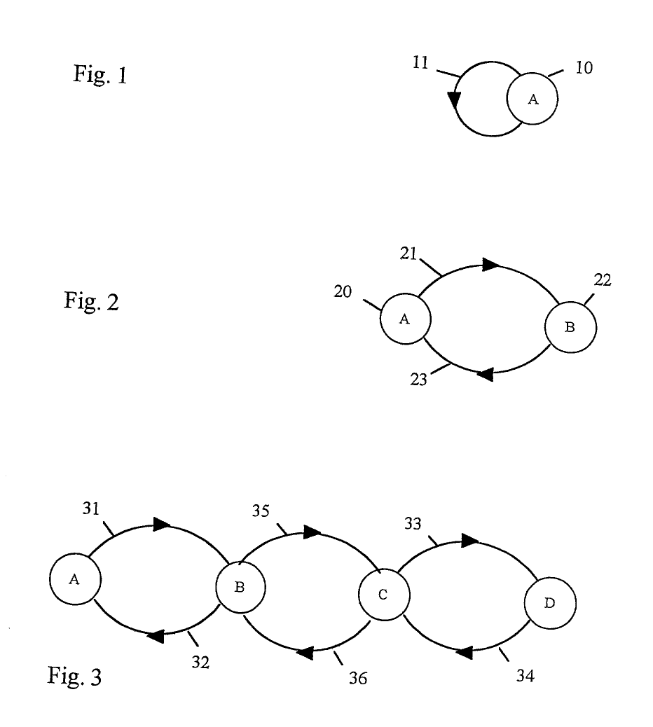

Recursion is a technique whereby a segment of program code, such as a function, procedure or other unit of program code, may cause itself to be invoked, either directly, or indirectly via the invocation of another segment. For example, a function A, 10, may call 11 the function A (FIG. 1); or function A, 20, may call 21 another function B, 22, which calls 23 function A (FIG. 2).

Recursion may be bounded or unbounded. In the above example, in FIG. 2, A might be constructed so as to always call 21 B whenever A is invoked. If B in turn calls 23 A whenever B is invoked, the recursion would be unbounded (i.e. 1never terminate). However, if B only sometimes calls A (depending perhaps on the parameters presented to B at the time B is called, or the state of the program variables), then after A and B have called each other a number of times, it may be that B returns to the point in the program from which B was originally called without calling A.

Bounded recursion is useful for example in traversing naturally recursive data structures such as expressions, trees and lists. Unbounded recursion is in general not useful; typically some area of memory (e.g. a call/return stack) will become exhausted and the program will be terminated.

In order to avoid a program crashing because of unbounded recursion, it is necessary to ensure that every recursive cycle is bounded. In the example already given in FIG. 2, it is necessary to ensure that whenever A is called, the cycle 21,23 A-calls-B-calls-A will be executed only a finite number of times, after which B returns to A without again calling A or A returns to B without again calling B.

Intersecting recursive cycles are multiple recursive cycles that pass through common points. For example, referring to FIG. 3, if A calls B, 31, and B calls A, 32, we have a cycle; similarly, if C calls D, 33, and D calls C, 34, we have a cycle; but these cycles are separate from each other, so they can be treated separately. However, if B calls C, 35, and C calls B, 36, we have three cycles and they intersect at two places (B and C). So to ensure that all recursive cycles are bounded, we have to ensure not only that the simple cycles ABA, BCB and CDC are bounded, we also need to consider cycles like ABCBA, ABCBCBA, ABCBCBCBA, ABCBCBCBCDCBA and so on (ie. within the cycle ABA we have to consider that after taking the path AB 31, the system may cycle round BC 35,36 and CD 33,34 an arbitrary number of times before returning to A).

There is a well-known method for ensuring that recursion is bounded when calls to segments of code are statically bound and the recursive cycles do not intersect. The method requires a variant expression to be defined at some point in each recursive cycle. The variant expression yields a value of a finite type with a defined lower bound. Typically, the variant is an expression whose type is some range of integers and the lower bound is defined as zero. It is required that the variant satisfy two properties. First, its value must never be less than the defined lower bound; second, if control flow passes through the point at which the variant is defined and then makes a recursive call such that control again passes the same point, the value of the variant at this later time is lower than its value at the earlier time. If these conditions are satisfied, the variant must decrease every time the control flow recurses and it must stop recursing when or before the lower bound is reached. It is possible to express these two conditions as hypotheses and to use mathematical techniques to attempt to prove them.

Unfortunately, this method fails to address two key aspects of recursion that may be present in modem programs:

a) There may be multiple intersecting recursive cycles. For example, in FIG. 3 there is no single point where we can define a variant such that it is passed in every possible recursive cycle.

b) Using object-oriented programming languages, the binding (or link) between a call and a segment of program code called is dynamic, i.e. is not known at the time the program is compiled; so that when a call is made, the target function, procedure or other code segment may be any one of an entire family of segments.

It is an object of the present invention at least to ameliorate these difficulties.

According to a first aspect of the invention there is provided a process of validating that a computer program segment with more than one path there-through is bounded, the program segment comprising a recursive cycle or a loop and the process comprising the steps of: a) assigning a variant ordered array to the cycle or loop, wherein members of the array are expressions derived from functions of variables and/or parameters of the program and the member at each position in the array represents a different path through the cycle or loop respectively; b) defining a predetermined ordered array of corresponding elements of predetermined values; c) creating a hypothesis that the value of the respective member of the array is decreased when the respective path is traversed and the values of the members at earlier positions in the array are unchanged; and that the value of the element of the variant ordered array is never less than the value of the corresponding element of the predetermined ordered array; and d) proving the hypothesis for each path through the program segment.

Conveniently, the program segment is a method of an object oriented program.

Advantageously, where the computer program segment is a loop which may perform any of a plurality of actions dependant on prevailing program conditions, step a) of assigning a variant ordered array comprises assigning a member of the array to each action respectively, and step c) comprises generating a hypothesis that the value of the respective member decreases when the corresponding action is performed and the order of the members is such that each action does not change the value of the members of the ordered array preceding the member corresponding to that action.

Alternatively, where the program segment is an isolated recursive cycle that does not intersect with any other cycle, but wherein the cycle can call itself in more than one way, step a) of assigning a variant ordered array comprises assigning a member of the array for each way in which the cycle can call itself respectively and step c) comprises generating a hypothesis that the value of the respective member decreases when the cycle calls itself in that way, respectively, and the order of the members is such that that way of calling itself does not change the value of the members of the ordered array preceding the member corresponding to that way of calling itself.

Alternatively, where the program segment comprises intersecting recursive cycles that intersect solely at a single point, step a) of assigning a variant ordered array comprises assigning a variant ordered array to the point where the recursive cycles intersect, wherein members of the array represent each of the intersecting cycles respectively.

Alternatively, where the program segment comprises recursive cycles that intersect with each other at a first plurality of points, step a) of assigning a variant ordered array comprises choosing a subset of these points such that each intersecting cycle passes through at least one point in the subset and assigning a variant ordered array to each point in this subset such that the corresponding members of each variant are of the same type so that the values thereof may be compared and step c) of creating a hypothesis comprises creating a hypothesis that for any path from a first point with a variant to the same point or to a second point with a variant, the path not passing through a third point with a third variant, the value of the corresponding member of the variant decreases and all preceding members of the arrays remain unchanged.

Advantageously, the variant arrays have different numbers of expressions and/or expression types but at least the first expression of every variant has the same type and when comparing two variants, only the at least the first expressions are compared and other trailing expressions in either variant are ignored.

Conveniently, each of the variant arrays for the program segment has an equal number of members.

Advantageously the step c) of creating a hypothesis comprises the further steps of: i) for every program segment of the program, producing a list of all other program segments of the program that directly or indirectly override that program segment, ii) for every program segment, producing a called list of all other program segments called directly by that program segment and for each member of the called list recording whether the call is statically or dynamically bound, and if statically bound recording the target program segment of the call and if dynamically bound recording the target program segment which is overridden by all other target program segments, recording whether target program segments are variant safe, that is whether they have an associated variant array if they are recursive; iii) producing a closure list for each program segment by listing the program segments called directly or indirectly by said program segment by associating a provisional closure list with said program segment comprising the called list for that program segment and adding to the provisional closure list the called list for each target program segment of that program segment; iv) removing the called list from any program segment whose closure list does not include the said program segment, and which are therefore not recursive program segments and removing members from the called lists of the remaining program segments any target program segments the closure lists of which do not include that target program segment and which are therefore not recursive; v) scanning through the remaining called lists for each program segment and for each member of the called lists not recorded as variant safe checking whether all possible target program segments are variant safe and if so recording the member as variant safe; vi) generating diagnostic messages for any program segments having members of the associated called list not recorded as variant safe; vii) for each program segment that declares or inherits a variant, using the called list to generate a tree of all possible paths starting from that program segment and terminating when a call to a program segment with a variant is reached and for each such possible path formulating a hypothesis whose antecedent is a set of conditions under which the path is entered and whose consequence is that some member of the variant of a final target program segment in the path has decreased relative to the corresponding member of the variant at the beginning of the path and all earlier members of the variant are unchanged relative to the corresponding members of the variant at the beginning of the path.

Conveniently, step ii) includes the further step of removing all entries in every called list which take no part in any recursive cycle and do not lead to a recursive cycle, by removing from the called list of each method all possible targets having empty called lists so that all remaining called list entries take part in recursive cycles.

Advantageously, when the program segment is a segment of an object-oriented program and the program segment is a method, the step a) of assigning a variant comprises the further step, whenever a variant is assigned to a class method, of all methods declared in classes derived from a class that overrides that method, inheriting the variant and optionally declaring for any overriding method additional variant expressions and appending the additional expressions to the inherited expressions.

According to a second aspect of the invention there is provided a system for validating that a computer program segment with more than one path there-through is bounded, the program segment comprising a recursive cycle or a loop and the system comprising: a) means for assigning a variant ordered array to the cycle or loop, wherein members of the array are expressions derived from functions of variables and/or parameters of the program and the member at each position in the array represents a different path through the cycle or loop respectively; b) means for defining a predetermined ordered array of corresponding elements of predetermined values; c) means for creating a hypothesis that the value of the respective member of the array is decreased when the respective path is traversed and the values of the members at earlier positions in the array are unchanged; and that the value of the element of the variant ordered array is never less than the value of the corresponding element of the predetermined ordered array; and d) means for proving the hypothesis for each path through the program segment.

Conveniently, the program segment is a method of an object oriented program.

Advantageously, where the computer program segment is a loop which may perform any of a plurality of actions dependant on prevailing program conditions, the means for assigning a variant ordered array comprises means for assigning a member of the array to each action respectively and the means for creating a hypothesis comprises means for creating a hypothesis that the value of the respective member decreases when the corresponding action is performed and the order of the members of the array is such that each action does not change the values of the members of the ordered array preceding the member corresponding to that action.

Alternatively, where the program segment is an isolated recursive cycle that does not intersect with any other cycle, but wherein the cycle can call itself in more than one way, the means for assigning a variant ordered array comprise means for assigning a member of the array for each way in which the cycle can call itself respectively and the means for creating a hypothesis comprises means for creating a hypothesis that the value of the respective member decreases when the cycle calls itself in that way and that that way of calling itself does not change the value of the members of the ordered array preceding the member corresponding to that way of calling itself.

Alternatively, where the program segment comprises intersecting recursive cycles that intersect solely at a single point, the means for assigning a variant ordered array comprises means for assigning a variant ordered array to the point where the recursive cycles intersect, wherein members of the array represent each of the intersecting cycles respectively.

Alternatively, where the program segment comprises recursive cycles that intersect with each other at a first plurality of points, the means for assigning a variant ordered array comprises means for choosing a subset of these points such that each intersecting cycle passes through at least one point in the subset and assigning a variant ordered array to each point in this subset such that the corresponding members of each variant are of the same type so that the values thereof may be compared and the means for creating a hypothesis comprise means for creating a hypothesis that for any path from a first point with a variant to the same point or to a second point with a variant, the path not passing through a third point with a third variant, the value of the corresponding member of the variant decreases and all preceding members of the arrays remain unchanged.

Advantageously, the variant arrays have different numbers of expressions and/or expression types but at least the first expression of every variant has the same type and when comparing two variants, only the at least the first expressions are compared and other trailing expressions in either variant are ignored.

Conveniently, each of the variant arrays for the program segment has an equal number of members.

Advantageously, the means for creating a hypothesis further comprises: i) for every program segment of the program, means for producing a list of all other program segments of the program that directly or indirectly override that program segment; ii) for every program segment, means for producing a called list of all other program segments called directly by that program segment and for each member of the called list means for recording whether the call is statically or dynamically bound, and if statically bound for recording the target program segment of the call and if dynamically bound for recording the target program segment which is overridden by all other target program segments, and for recording whether target program segments are variant safe, that is whether they have an associated variant array if they are recursive; iii) means for producing a closure list for each program segment by listing the program segments called directly or indirectly by said program segment by associating a provisional closure list with said program segment comprising the called list for that program segment and adding to the provisional closure list the called list for each target program segment of that program segment; iv) means for removing the called list from any program segment whose closure list does not include the said program segment, and which are therefore not recursive program segments and for removing members from the called lists of the remaining program segments any target program segments the closure lists of which do not include that target program segment and which are therefore not recursive; v) means for scanning through the remaining called lists for each program segment and for each member of the called lists not recorded as variant safe checking whether all possible target program segments are variant safe and if so for recording the member as variant safe; vi) means for generating diagnostic messages for any program segments having members of the associated called list not recorded as variant safe; vii) for each program segment that declares or inherits a variant, means for using the called list to generate a tree of all possible paths starting from that program segment and terminating when a call to a program segment with a variant is reached and for each such possible path means for formulating a hypothesis whose antecedent is a set of conditions under which the path is entered and whose consequence is that some member of the variant of a final target program segment in the path has decreased relative to the corresponding member of the variant at the beginning of the path and all earlier members of the variant are unchanged relative to the corresponding members of the variant at the beginning of the path.

Conveniently, the means for producing a called list further comprises means for removing all entries in every called list which take no part in any recursive cycle and do not lead to a recursive cycle, by removing from the called list of each method all possible targets having empty called lists so that all remaining called list entries take part in recursive cycles.

Advantageously, when the program segment is a segment of an object-oriented program and the program segment is a method, the means for assigning a variant further comprises, whenever a variant is assigned to a class method, all methods declared in classes derived from a class that overrides that method, means for inheriting the variant and optionally declaring for any overriding method additional variant expressions and means for appending the additional expressions to the inherited expressions.

The invention has the advantage of using a novel form of variant expression such that it is possible, to derive hypotheses that, if proven, ensure that recursion is bounded, even in the presence of multiple intersecting recursion cycles and dynamic binding. The novel form of variant expression can also be used to ensure that a loop terminates after a finite number of iterations and in this context it frequently simplifies the task of the programmer compared with the use of a traditional single expression variant.

A specific embodiment of the invention will now be described by way of example with reference to the accompanying drawings in which:

FIG. 1 illustrates a simple recursive cycle;

FIG. 2 illustrates a single cycle of indirect recursion involving two calls;

FIG. 3 illustrates multiple intersecting cycles of recursion;

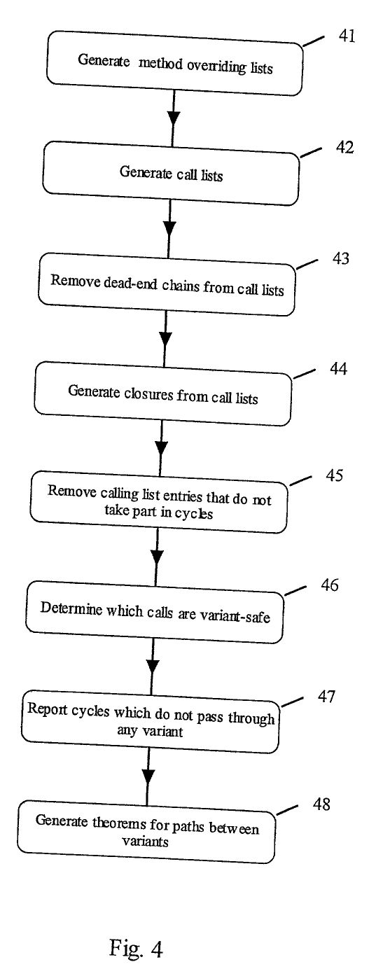

FIG. 4 is a flowchart of an overview of the steps taken to locate recursive cycles and generate the appropriate hypotheses;

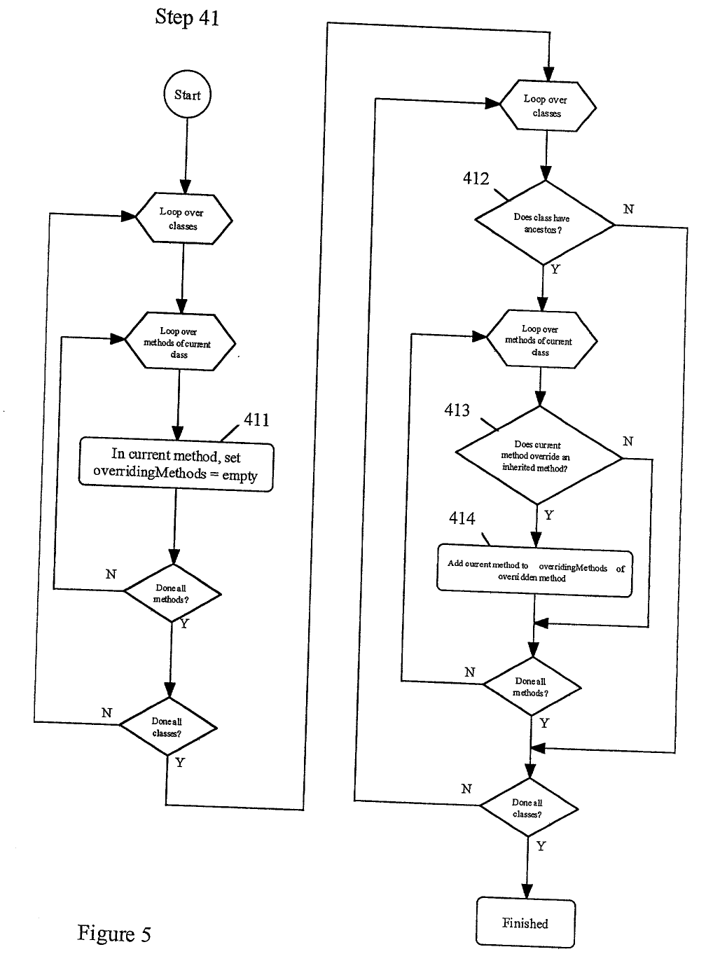

FIG. 5 is a flowchart showing details of step 41 of FIG. 4;

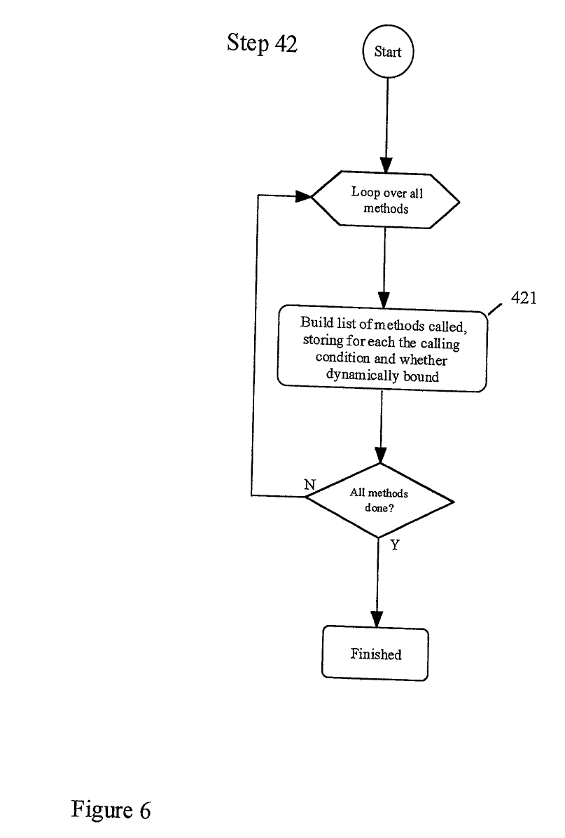

FIG. 6 is a flowchart showing details of step 42 of FIG. 4;

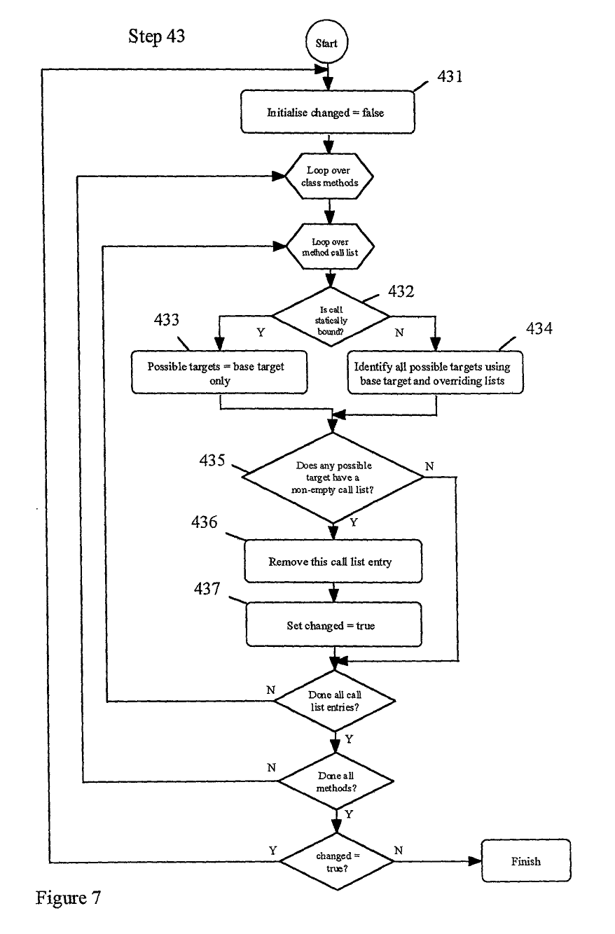

FIG. 7 is a flowchart showing details of step 43 of FIG. 4;

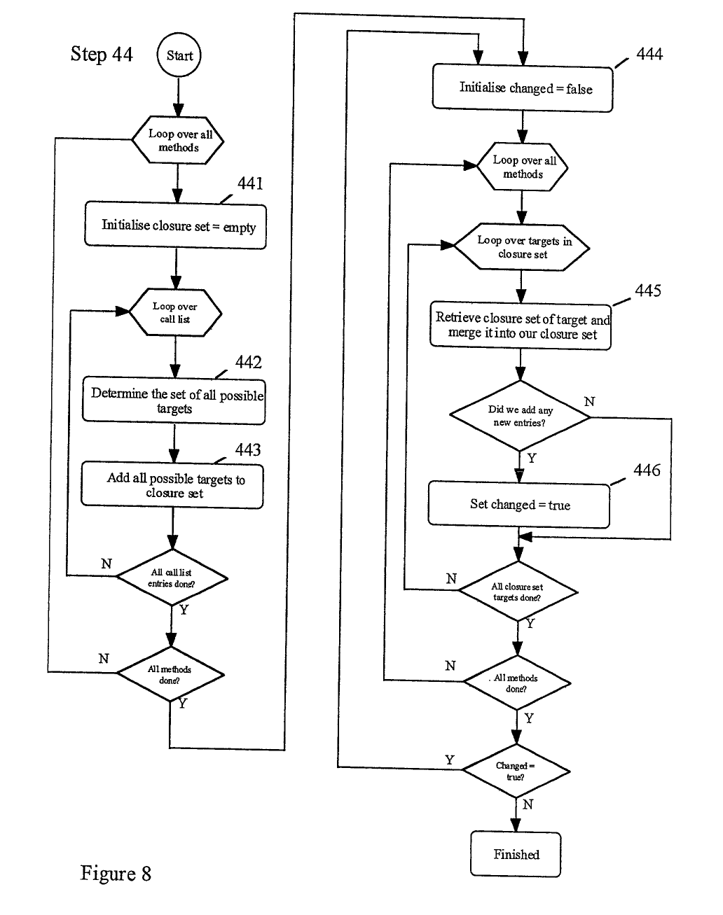

FIG. 8 is a flowchart showing details of step 44 of FIG. 4;

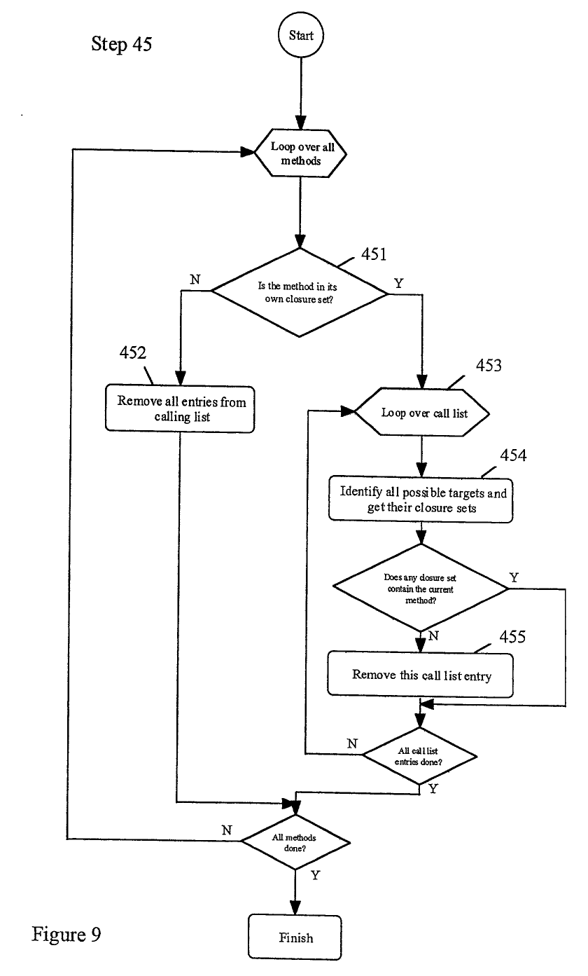

FIG. 9 is a flowchart showing details of step 45 of FIG. 4;

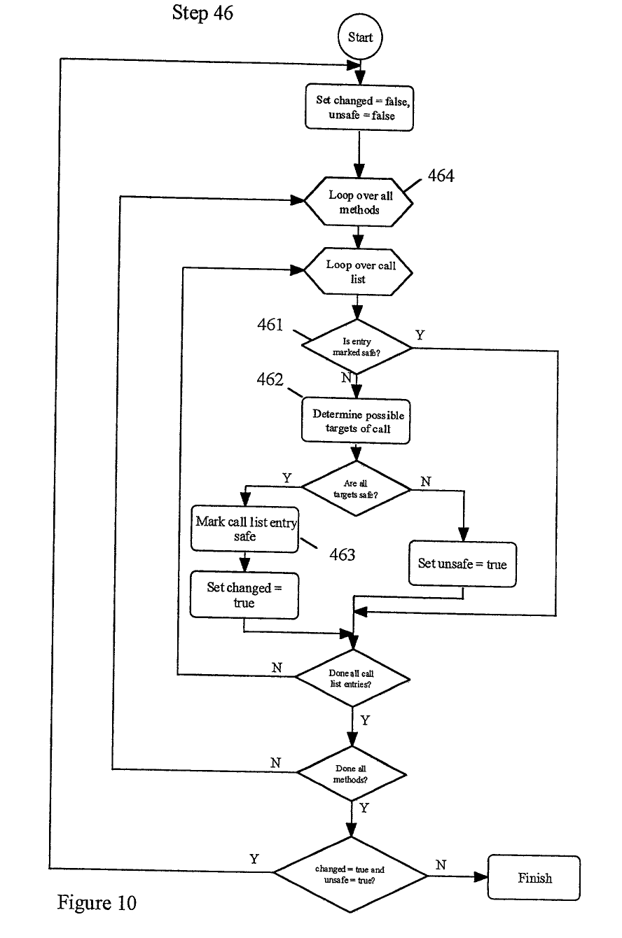

FIG. 10 is a flowchart showing details of step 46 of FIG. 4;

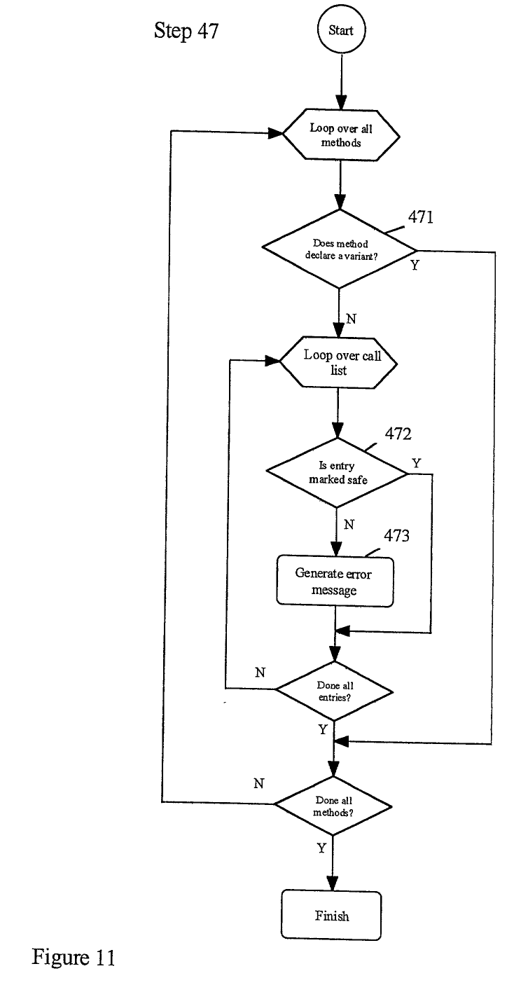

FIG. 11 is a flowchart showing details of step 47 of FIG. 4; and

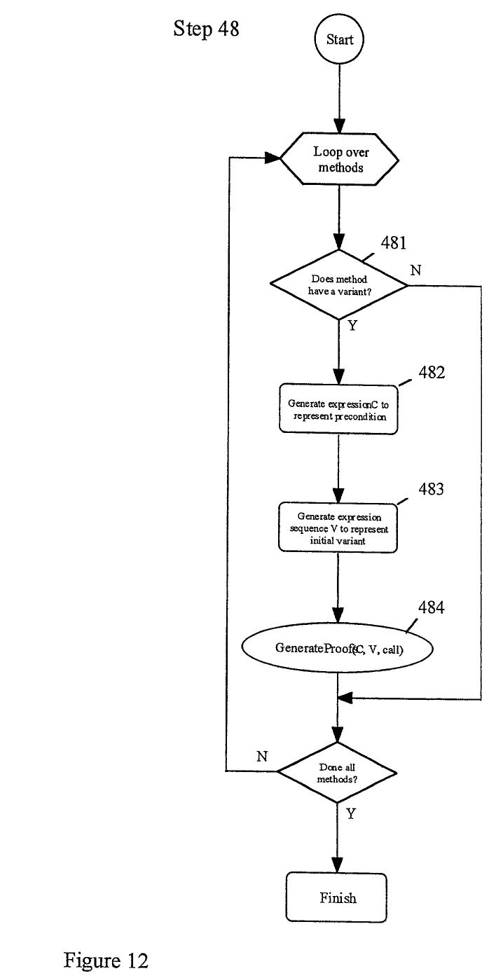

FIGS. 12, 13 and 14 are flowcharts showing details of step 48 of FIG. 4.

The invention comprises a computer system and process for developing software embodying a means of annotating the program being developed with variant expressions of a novel form, together with a means of automatically generating hypotheses that express the conditions that the number of iterations of each loop is bounded and each recursion cycle is bounded.

Instead of using a variant comprising a single expression whose value has a defined tower bound and a finite number of values, the variant comprises a finite sequence of expressions, each of which has a value with a defined lower bound and a finite number of values. It is not necessary for all the expressions in the sequence to be of the same type. The type of a variable or expression is defined by the set of values it may have. Typical types include: integer, boolean, character, string and real. Modem programming languages also allow user-defined types.

We define the following conditions for the variant having a sequence of expressions:

1. Whenever control passes through the point for which the variant is defined, each expression in the variant must have a value that is not below the respective lower bound for that expression;

2. When control passes through the point at which the variant is defined and then re-passes through the same point due to iteration or recursion, it must be possible to identify an expression at a position in the sequence such that the value of that expression has decreased compared to its value during the preceding pass and that the values of all expressions at the earlier positions in the sequence are unchanged from their values during the preceding pass.

These conditions guarantee that the iteration or recursion will terminate.

In the remainder of this description, reference to a multi-expression variant as having decreased, means that condition (2) above has been satisfied.

This form of variant may be applied to program loops and recursion as follows.

1. Program Loops

Quite often in programming, a particular loop body may accomplish one of several actions depending on the prevailing conditions. In such cases, using the form of variant of the invention, it is often possible to construct a variant comprising one expression for each of these actions, such that each respective expression decreases when the corresponding action is performed. It is only necessary to find an order for the expressions such that the action corresponding to each expression does not change the value of the preceding expressions. For example, suppose the body of a loop comprises an IF-statement that performs action A, B or C depending on the conditions. To be able to prove termination, we need to find a variant that will decrease whichever of these alternatives is taken. Suppose we find expressions a, b and c such that a decreases when action A is performed, b decreases if B is performed and similarly c decreases if C is performed. Suppose it also happens that when A is performed, the values of b and c are unaffected; when B is performed, the values of a and c are unaffected, but when C is performed, not only is c decreased but a and b are increased as well. In order to ensure that the variant will decrease (according to our definition of what it means for a multi-expression variant to decrease), we must choose to order these expressions in the variant as either c,a,b or c,b,a. If we don't put c first, then when action C is performed, the variant will not decrease.

2. Isolated Recursive Cycles

For a recursive cycle of “method” calls (where “method” means a function, procedure or program segment) that does not intersect with any other such cycle, it can be guaranteed that the recursion is bounded by defining a suitable variant for any one of the methods in the cycle and then generating and proving the corresponding hypotheses. Sometimes a method may call itself recursively in more than one way and it is hard to construct a single variant that decreases in all cases. However, using the form of variant with an array of expressions of the invention, a variant can be constructed comprising one expression for each way the method recurses, again choosing a suitable order for the expressions in the variant to ensure that the variant decreases (as defined above) for any of the methods.

3. Intersecting Recursive Cycles that Intersect with Each Other Solely at a Call to a Single Method

In this case it can be guaranteed that the recursion is bounded by defining a suitable variant for the method where the calls intersect and then generating and proving the corresponding hypotheses for each of the possible cycles, taking that method as the starting point of each cycle. This allows each cycle to be treated independently of the others, rather than having to consider in one cycle the possibility of going round the other cycle(s) an indefinite number of times before returning to the starting point of the original cycle. Using the variant of the invention, it may be convenient to have one expression in the variant corresponding to each of the intersecting cycles.

4. Recursive Cycles that Intersect with Each Other at More Than One Point

In this case, variants are defined for multiple methods such that each cycle passes through at least one method with a variant. In principle, to ensure all recursive cycles are bounded, we require only that for every cycle, at least one variant in the cycle decreases. A problem arises because the number of possible cyclic paths becomes huge, because a cycle may contain many instances of other cycles within it. For example, referring to FIG. 3 if variants are declared for methods A and C then we need to consider the cycles ABA, CBC, CDC, ABCBA, ABCBCBA, ABCDCBA, ABCBCDCBA and so on. Unfortunately, it is not easy to construct a general formula describing the state of the program after a variable number of recursive cycles have been followed.

An alternative mechanism is therefore used to ensure that recursion is bounded. All the variants in the set of intersecting cycles are made to have the same number of expressions of corresponding expression types, and it is required that for every path from one point with a variant to the same or another adjacent point with a variant (i.e. excluding paths that pass through any other point with a variant on the way), the variant at the end point must have decreased compared to the variant at the starting point. In the example of FIG. 3 we could declare variants for methods B and C and check that the variant decreases for each of the paths BAB, BC, CB and CDC.

It is not necessary that the two variants have an expression in common (although they may well do so). For example, suppose we have variables X and Y, the variant at point A has the form “ . . . ,X” and the variant at point B has the form “ . . . ,Y” (where the “ . . . ” represent the same number of expressions in both cases). Then if on the path from A to B we pass a statement such as “Y:=X−1” (i.e. Y is assigned the value X−1), we can say that this component of the variant at B is less than the corresponding component of the variant at A.

The condition we require to prove boundedness is that on any path between two points A and B in a recursive cycle at which variants are declared (and not passing any other points with variants), the variant at B is less than the variant at A, i.e. either the first expression of the variant declared at B is less than the first expression of the variant declared at A, or those two expressions are equal but the second expression of variant B is less than the second expression of variant A respectively, or the first two expressions of variant B are equal to the first two expressions of variant A but the third expression of variant B is less than the third expression of variant A, and so on (and, as usual, none of the expressions has a value below the defined lower bound).

This scheme may be generalised by permitting the various variants to have different numbers of expressions and/or different expression types. Then for each pair of points with variants that are connected by a direct path not passing through any other point with a variant, we compare the number of expressions and the types of the expressions. We take the first N expressions of each variant, where N is the largest number such that each variant has at least N expressions and the types of the first N expressions in one variant match the types of the first N expressions in the other respectively. To prove recursion is bounded, we require that the variant at the end point has decreased with respect to the variant at the start point when we consider only the first N expressions of each.

As before, the variant at the end point need not contain the same expression as the variant at the start point, it is only necessary that at least some of the expressions in the end variant are of the same types as the corresponding expressions at the start point (because expressions of different types cannot be compared to see which is the larger).

The process of checking that looping and recursion is bounded may be automated.

Most programs provide loop constructs and it is a simple matter to check that a variant has been specified for each such construct. Where no variant has been specified, various techniques of attempting to deduce a suitable variant can be used. If the language allows jump-statements, these too may give rise to loops. This may be handled either by banning backward jumps from the language, or by requiring a variant to be associated either with each backward jump or with each label to which there is a backward jump; whichever of these rules has been chosen, it is a simple matter to check that it is complied with.

To check for recursion, the system must identify all possible recursive cycles. This may be done using the following process. Although it is described here in several steps for clarity (illustrated in FIG. 4), it is straightforward to combine some of the steps to improve efficiency. In the following, we refer to functions, procedures and other code segments as “methods” as is usual in object-oriented programming, however the process is also applicable to non-object-oriented systems. We allow for the fact that when object-oriented programming languages are used, the target of a call may not be statically determined at compile time, but may be dynamically bound (or linked) at run-time to any of a set of methods, that set comprising a method declared in some class together with all those methods declared in classes derived from the original class that directly or indirectly override the original method.

The concept of overriding the original method may be understood as follows. Using object-oriented programming languages, the developer defines classes, where a class is a collection of data variables together with functions, procedures etc (collectively called ‘methods’). One of the facilities of object-oriented languages is class inheritance, whereby a new class is defined as inheriting another class. The methods of the old class are inherited into the new class; however it is also possible to define new methods in the new class with the same names and parameters as inherited methods. These new methods then override the old ones with the same names.

As an example, suppose a class “Employee” is declared with data variables “Name”, “Address” and “Salary”. A method called “Print” might be defined that prints these details on the screen. Then to declare a class “Salesmen”, who are also employees, “Salesmen” is declared to inherit from “Employee”. In class Salesman a variable called “Commission” is also declared. Now, the inherited method “Print” can still be used to print details of a salesman, however the inherited method does not know about the commission. If it is required that “Print” print the commission note as well, the inherited definition of “Print” has to be overridden by defining a new method called “Print” (which is possibly defined as calling the overridden version of Print and then printing the commission).

Step 41: Referring to FIG. 5, for every method in the system, a list of all other methods is recorded that directly or indirectly override the first method (we shall refer to this list as the “overriding list”). This allows easy identification of all possible targets of a dynamically bound call. This is done by initialising, step 411, overridingMethods to an empty list and for each method determining, step 412, whether the class has ancestors and if so determining, step 413, whether the current method overrides the inherited method and, if so, adding, step 414, the current method to overridingMethods of the overridden method.

Step 42: Referring to FIG. 6, for every method definition in the system, a list of all other methods it calls is constructed, step 421, (we shall refer to this list as the “calling list”). For each element in the calling list, we record the following:

Whether the call is statically or dynamically bound;

If it is statically bound, the single target of the call; if it is dynamically bound, that target of all the possible targets that is directly or indirectly overridden by all other possible targets (the “nominal target”);

Whether all possible targets are “safe”, i.e. known not to partake in recursive cycles without a variant being involved; this is initialised to “true” if all possible target methods declare or inherit a variant;

The conditions under which the call is made, the values of the parameters passed and the values of any global variables already modified by the method (all in terms of the method input parameters and values of global variables at method entry)

Step 43 (optional): Referring to FIG. 7, remove all entries in every calling list that take no part in any recursive cycle and do not lead to a recursive cycle (i.e. entries within calling chains that lead to “dead ends”). This step is not essential but if performed, the following step can be performed more quickly as there will be fewer calling list entries to examine. To do this, a variable “changed” is initialised, step 431, to “false” and every method is processed checking each entry in its calling list and examining all possible targets of that entry. To do this it is first determined, step 432, whether a call is statically bound and if so setting, step 433, the target as the base target and if not, identifying, step 434, all possible targets, using the base target and the overriding lists derived in step 41. It is then determined, step 435, whether any possible targets have empty calling lists, and if so the call list entry is removed, step 436. The variable “changed” is then set, step 437, to “true” and repeated passes are made, processing all methods in this way until a pass is made which does not result in any calling list entries being removed. At the end of this process, all remaining calling list entries take part in recursive cycles or in call chains leading to recursive cycles.

Step 44: Referring to FIG. 8, calculate the closure of the calling lists for each method (i.e. the set of all methods that can be reached from it). This is done by initialising a closure set to empty, step 441, determining, step 442, the set of all possible targets and adding, step 443, all possible targets to the closure set, thereby associating a provisional closure set with each method and initialising the provisional closure set to the set of all possible targets from all entries in its calling list. Repeated passes are then made through all methods, each time updating the provisional closure set for each method by adding to it the provisional closure sets of all possible targets from all entries in its calling list. This is done by initialising, step 444, a variable “changed” to “false” and then for each target in each method retrieving, step 445, the closure set of the target and merging it into the provisional closure set. No further passes are made when a pass is made that added no new entries to any closure set, as determined by the variable “changed” remaining “false” at the end of the pass at which point the provisional closure sets have become the complete closure sets.

Step 45: Referring to FIG. 9, remove calling list entries that do not take part in a recursive cycle. To do this, clear (i.e. make empty) the calling list of every method whose closure set does not contain that method, since such a method does not partake in any recursive cycle. This is done by determining, step 451, for each method whether the method is in its own closure set and if not, removing, step 452, all entries from the calling list. Otherwise, those elements of its calling list for which no possible target has a closure set containing the original method are removed. This is done by, for every method which is not in its own closure set, looping through its call list elements, step 453, and identifying, step 454, all possible targets and their closure sets and if no closure set contains the original method, removing, step 455, this call list entry. The closure sets may then be discarded.

Step 46: Referring to FIG. 10, determine whether each recursive cycle passes through at least one method with a variant. A method is defined to be safe if the method either declares a variant or the method has no entries in its calling list that are not marked safe. For each method, scan, step 461, through its calling list and for each element that is not marked safe, check, step 462, whether all its possible targets are safe; if so, mark, step 463, the element safe. Make multiple passes, step 464, through all the methods until no further calling list entries are changed.

Step 47: Referring to FIG. 1, if there are any calling list entries left that are not marked safe, generate diagnostic messages to report the presence of recursive cycles that do not pass through methods with variants. This is done by, for every method checking, step 471, when the method declares a variant, and if not for every call list, checking, step 472, whether the entries are marked safe and if not generating, step 473, an error message.

Step 48: Referring to FIG. 12, 13 and 14, generate hypotheses to represent the decrease between each variant and the next in every recursive cycle, as follows. For each method determine, step 481, whether the method has a variant and for each method that declares or inherits a variant, use the calling lists to generate a tree representing all possible paths that start at that method and terminate when a call to a method with a variant is reached. For each such path we formulate an hypothesis whose antecedent is the set of conditions under which the path is taken and whose consequence is that the variant of the final target in the path has decreased relative to the variant at the start of the path (taking only the first N expressions in each variant, as described earlier). This is done by, for every method that has a variant, generating, step 482, an expression to present the precondition and generating, step 483, an expression sequence V to represent the initial variant. A procedure generateProofs, step 484, is then carried out for each expression, variant and call.

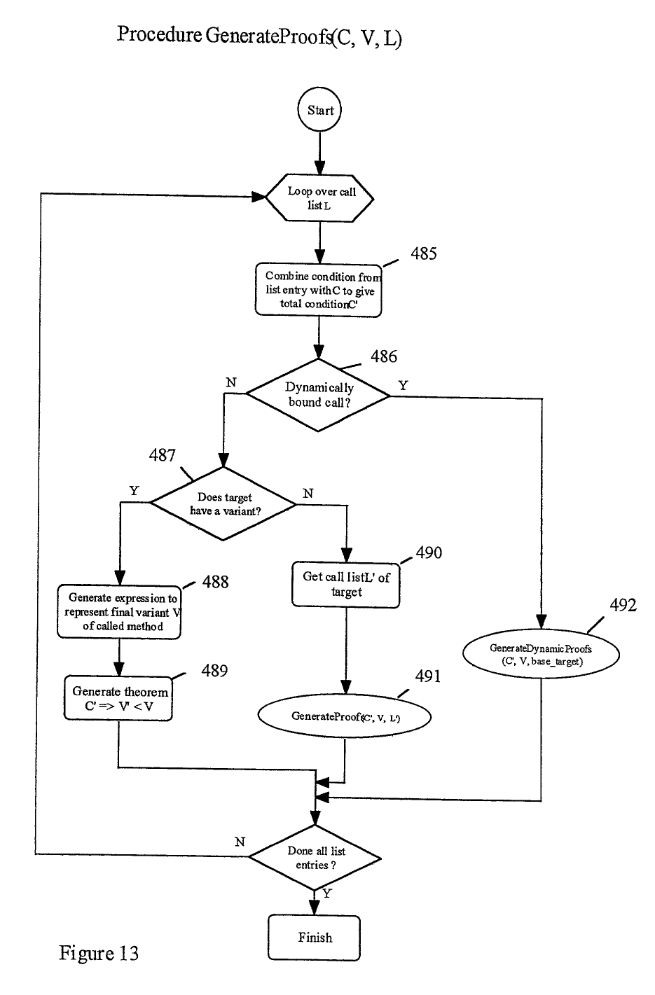

Details of the generateProofs procedure are shown in FIG. 13, in which, for each entry in the call list, the conditions from the list entry are combined with the expression C to give a give a total condition C′, step 485. It is then determined, step 486, whether the call is dynamically bound and if not it is determined, step 487, whether the target has a variant. If the target has a variant, an expression is generated, step 488, to represent the final variant V′ of the called method and a corresponding hypothesis is generated, step 489. If the target does not have a variant, the call list L′ of the target, is obtained, step 490, and the generateProofs procedure is carried out for C′, V and L′, step 491. If it was determined, step 486, that the call was dynamically bound, then a generateDynamicProofs procedure for the total condition C′, each variant and base target is carried out, step 492.

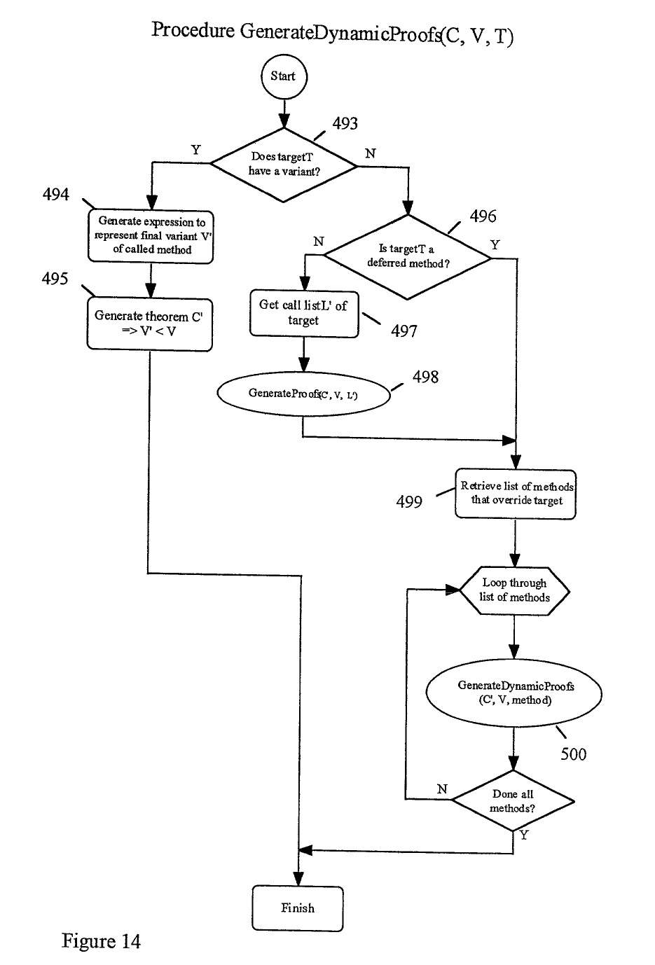

The generateDynamicProofs procedure is illustrated in FIG. 14, where it is first determined, step 493, whether the target T has a variant, and if so, an expression is generated, step 494, to represent the final variant V′ of the call method and a hypothesis generated, step 495. If in step 493 it is determined the target does not have a variant, then it is determined, step 496, whether the target is a deferred method and if not, the call list L′ of the target is obtained, step 497, and the generateProofs procedure is carried out, step 498, for C′, V and L′. If it is determined in step 496, that the target is a deferred method, a list of methods that ;override that target is retrieved, step 499, and then for all methods the procedure generateDynamicProofs is carried out, step 500 for C′, V and each method.

Although this process handles recursion involving dynamic binding, the number of possible paths between variants may become very large when dynamic binding is used. The invention introduces the following mechanisms to reduce the number of paths that need to be considered:

1. Whenever a variant is declared for a class method, all methods declared in classes derived from that class that override that method inherit the variant;

2. A means is provided for the user to declare for any overriding method additional variant expressions, which are then appended to the inherited variant.

Where a call list entry represents a dynamically bound call whose nominal target declares a variant, then when considering paths terminating in a call represented by that call list entry, it would normally be necessary to generate a separate path for each possible target of that call. However, because of mechanism (1) only the path that terminates by calling the nominal target need be considered. This is because whenever it is proved that a variant decreases over that path, it is guaranteed that the variant will also decrease on all the other paths (i.e. paths that differ only in that the last call in the path is to some target that overrides the nominal target), because mechanism (1) ensues that all other targets inherit the same variant. Mechanism (2) adds flexibility to make it easier to construct suitable variants where there are other recursive cycles involving dynamic bindings whose nominal targets are themselves methods that override other methods.

1. A process of validating that a computer program segment with more than one path therethrough is bounded, the computer program segment comprising a recursive cycle or a loop and the process comprising the steps of:
a) assigning a variant ordered array to the cycle or loop, wherein members of the array are expressions derived from functions of variables and/or parameters of the program and the member at each position in the array represents a path through the cycle or loop;
b) defining a predetermined ordered array of corresponding elements of predetermined values;
c) creating a hypothesis that the value of the respective member of the array is decreased when the corresponding path is traversed and the value of the members at earlier positions in the array are unchanged; and that the value of the element of the variant ordered array is never less than the value of the corresponding element of the predetermined ordered array; and
d) proving the hypothesis for each path through the program segment.

2. A process as claimed in claim 1, wherein the program segment is a method of an object oriented program.

3. A process as claimed in claim 1, wherein the computer program segment is a loop which may perform any of a plurality of actions dependant on prevailing program conditions, and step a) of assigning a variant ordered array comprises assigning a member of the array to each action such that the value of the member decreases when the corresponding action is performed, and steps c) and d) of creating and proving a hypothesis comprise finding an order of the members of the array such that each action does not change the value of the members of the ordered array preceding the member corresponding to that action.

4. A process as claimed in claim 1, wherein the program segment is an isolated recursive cycle that does not intersect with any other cycle, but wherein the cycle can call itself in more than one way, and step a) of assigning a variant ordered array comprises assigning a member of the array for each way in which the cycle can call itself, and steps c) and d) of creating and proving a hypothesis comprise finding an order of the members of the array such that way of calling itself does not change the value of the members of the ordered array preceding the member corresponding to that way of calling itself.

5. A process as claimed in claim 1, wherein the program segment comprises intersecting recursive cycles that intersect solely at a single point and wherein step a) of assigning a variant ordered array comprises assigning a variant ordered array to the point where the recursive cycles intersect, wherein members of the array represent each of the intersecting cycles respectively.

6. A process as claimed in claim 1, wherein the program segment comprises recursive cycles that intersect with each other at a first plurality of points, wherein step a) of assigning a variant ordered array comprises assigning a variant ordered array to each intersecting cycle such that each variant has at least a second plurality of members and corresponding members of the second plurality of members of each variant are of the same type so that the values thereof may be compared, and step c) of creating a hypothesis comprises creating a hypothesis that for any path from a first point with a variant to the same point or to a second point with a variant, not passing through a third point with a third variant, the value of the corresponding member of the variant decreases and all preceding members of the arrays remain unchanged.

7. A process as claimed in claim 6, wherein each of the variant arrays for the program segment has an equal number of members.

8. A process as claimed in claim 1, wherein the step c) of creating a hypothesis comprises the further steps of:
i) for every program segment of the program, producing a list of all other program segments of the program that directly or indirectly override that program segment;
ii) for every program segment, producing a called list of all other program segments called directly by that program segment and for each member of the called list recording whether the call is statically or dynamically bound, and if statically bound recording the target program segment of the call and if dynamically bound recording the target program segment which is overridden by all other target program segments, recording whether target program segments are variant safe, that is whether they have an associated variant array if they are recursive;
iii) producing a closure list for each program segment by listing the program segments called directly or indirectly by said program segment by associating a provisional closure list with said program segment comprising the called list for that program segment and adding to the provisional closure list the called list for each target program segment of that program segment;
iv) removing the called list from any program segment whose closure list does not include the said program segment, and which are therefore not recursive program segments and removing members from the called lists of the remaining program segments any target program segments the closure lists of which do not include that target program segment and which are therefore not recursive;
v) scanning through the remaining called lists for each program segment and for each member of the called lists not recorded as variant safe checking whether all possible target program segments are variant safe and if so recording the member as variant safe;
vi) generating diagnostic messages for any program segments having members of the associated called list not recorded as variant safe; and
vii) for each program segment that declares or inherits a variant, using the called list to generate a tree of all possible paths starting from that program segment and terminating when a call to a program segment with a variant is reached and for each such possible path formulating a hypothesis whose antecedent is a set of conditions under which the path is entered and whose consequence is that the corresponding member of the variant of a final target program segment in the path has decreased and all earlier members of the variant are unchanged relative to the members of the variant at the beginning of the path.

9. A process as claimed in claim 8, wherein step ii) includes the further step of removing all entries in every called list which take no part in any recursive cycle and do not lead to a recursive cycle, by removing from the called list of each method all possible targets having empty called lists so that all remaining called list entries take part in recursive cycles.

10. A process as claimed in claim 8, wherein when the program segment is a segment of an object-oriented program and the program segment is a method, the step a) of assigning a variant comprises the further step, whenever a variant is assigned to a class method, of all methods declared in classes derived from a class that overrides that method, of inheriting the variant and declaring for any overriding method additional variant expressions and appending the additional expressions to the inherited expressions.

11. A system for validating that a computer program segment with more than one path therethrough is bounded, the program segment comprising a recursive cycle or a loop and the system comprising:
a) means for assigning a variant ordered array to the cycle or loop, wherein members of the array are expressions derived from functions of variables and/or parameters of the program and the member at each position in the array represents a path through the cycle or loop;
b) means for defining a predetermined ordered array of corresponding elements of predetermined values;
c) means for creating a hypothesis that the value of the respective member of the array is decreased when the corresponding path is traversed and the value of the members at earlier positions in the array are unchanged; and that the value of the element of the variant ordered array is never less than the value of the corresponding element of the predetermined ordered array; and
d) means for proving the hypothesis for each path through the program segment.

12. A system as claimed in claim 11, wherein the program segment is a method of an object oriented program.

13. A system as claimed in claim 11, wherein the computer program segment is a loop which may perform any of a plurality of actions dependant on prevailing program conditions, and the means for assigning a variant ordered array comprises means for assigning a member of the array to each action, such that the value of the member decreases when the corresponding action is performed, and the means for creating and proving a hypothesis comprise means for finding an order of the members of the array such that each action does not change the value of the members of the ordered array preceding the member corresponding to that action.

14. A system as claimed in claim 11, wherein the program segment is an isolated recursive cycle that does not intersect with any other cycle, but wherein the cycle can call itself in more than one way, and the means for assigning a variant ordered array comprises means for assigning a member of the array for each way in which the cycle can call itself, and the means for creating and proving a hypothesis comprise means for finding an order of the members of the array such that way of calling itself does not change the value of the members of the ordered array preceding the member corresponding to that way of calling itself.

15. A system as claimed in claim 11, wherein the program segment comprises intersecting recursive cycles that intersect solely at a single point, and wherein the means for assigning a variant ordered array comprises means for assigning a variant ordered array to the point where the recursive cycles intersect, wherein members of the array represent each of the intersecting cycles respectively.

16. A system as claimed in claim 11, wherein the program segment comprises recursive cycles that intersect with each other at a first plurality of points, wherein the means for assigning a variant ordered array comprises means for assigning a variant ordered array to each intersecting cycle such that each variant has at least a second plurality of members and corresponding members of the second plurality of members of each variant are of the same type so that the values thereof may be compared and the means for creating a hypothesis comprises means for creating a hypothesis that for any path from a first point with a variant to the same point or to a second point with a variant, not passing through a third point with a third variant, the value of the corresponding member of the variant decreases and all preceding members of the arrays remain unchanged.

17. A system as claimed in claim 16, wherein each of the variant arrays for the program segment has an equal number of members.

18. A system as claimed in claim 11, wherein the means for creating a hypothesis further comprises:
i) for every program segment of the program, means for producing a list of all other program segments of the program that directly or indirectly override that program segment;
ii) for every program segment, means for producing a called list of all other program segments called directly by that program segment, and for each member of the called list means for recording whether the call is statically or dynamically bound, and if statically bound for recording the target program segment of the call, and if dynamically bound for recording the target program segment which is overridden by all other target program segments, for recording whether target program segments are variant safe, that is whether they have an associated variant array if they are recursive;
iii) means for producing a closure list for each program segment by listing the program segments called directly or indirectly by said program segment by associating a provisional closure list with said program segment comprising the called list for that program segment and adding to the provisional closure list the called list for each target program segment of that program segment;
iv) means for removing the called list from any program segment whose closure list does not include the said program segment, and which are therefore not recursive program segments and for removing members from the called lists of the remaining program segments any target program segments the closure lists of which do not include that target program segment and which are therefore not recursive;
v) means for scanning through the remaining called lists for each program segment and for each member of the called lists not recorded as variant safe, and for checking whether all possible target program segments are variant safe and if so for recording the member as variant safe;
vi) means for generating diagnostic messages for any program segments having members of the associated called list not recorded as variant safe;
vii) for each program segment that declares or inherits a variant, means for using the called list to generate a tree of all possible paths starting from that program segment and terminating when a call to a program segment with a variant is reached and for each such possible path means for formulating a hypothesis whose antecedent is a set of conditions under which the path is entered and whose consequence is that the corresponding member of the variant of a final target program segment in the path has decreased and all earlier members of the variant are unchanged relative to the members of the variant at the beginning of the path.

19. A system as claimed in claim 18, wherein the means for producing a called list further comprises means for removing all entries in every called list which take no part in any recursive cycle and do not lead to a recursive cycle, by removing from the called list of each method all possible targets having empty called lists so that all remaining called list entries take part in recursive cycles.

20. A system as claimed in claim 18, wherein when the program segment is a segment of an object-oriented program and the program segment is a method, and the means for assigning a variant further comprises, whenever a variant is assigned to a class method, of all methods declared in classes derived from a class that overrides that method, means for inheriting the variant and declaring for any overriding method additional variant expressions and means for appending the additional expressions to the inherited expressions.
